(19) United States
(12) Patent Application Publication
(10) Pub. No.: US 2014/0026873 A1
(43) Pub. Date: Jan. 30, 2014

(54) Variable Miller Cycle for Reactivity Controlled Compression Ignition Engine and Method

(71) Applicants: Christopher Gehrke, Chillicothe, IL (US); George Donaldson, Chillicothe, IL (US)

(72) Inventors: Christopher Gehrke, Chillicothe, IL (US); George Donaldson, Chillicothe, IL (US)

(73) Assignee: CATERPILLAR INC., Peoria, IL (US)

(21) Appl. No.: 13/559,872

(22) Filed: Jul. 27, 2012

(51) Int. Cl. F02D 41/26; F02B 47/08; F02M 25/07

(52) U.S. Cl. 123/568.11

(57) ABSTRACT

A four stroke internal combustion engine includes least one cylinder having a reciprocable piston, a first fuel injector disposed to inject a first fuel into said cylinder, and a second fuel injector disposed to inject a second fuel into said cylinder. At least one intake valve of said cylinder is configured to open and close with a variable timing in accordance with a Miller thermodynamic cycle. An exhaust gas recirculation system, provides exhaust gas to said cylinder through the intake valve. An electronic controller is disposed to receive at least one input signal indicative of the operating conditions of the internal combustion engine, and adjusts at least one of the intake valve timing and the amount of exhaust gas recirculation.

### TECHNICAL FIELD

This patent disclosure relates generally to internal combustion engines and, more particularly to internal combustion engines operating on a variable Miller cycle using more than one fuel.

### BACKGROUND

Internal combustion engines operating with more than one fuel are known. Certain engines use two or more fuels having different reactivities. One example of such an engine can be seen in U.S. Patent Application Pub. No. 2011/0192367, which was published on Aug. 11, 2011 to Reitz et al. (hereafter, “Reitz”). Reitz describes a compression ignition engine that uses two or more fuel charges having two or more reactivities to control the timing and duration of combustion. However, as Reitz describes, engine power output and emissions depends on the reactivity of the fuels, temperature, equivalence ratios and many other variables, which in real-world engine applications cannot be fully controlled. For example, fuel quality may change by season or region, and the temperature of incoming air to the engine depends on the climatic conditions in which the engine operates. Moreover, other parameters such as altitude and humidity can appreciably affect engine operation.

Engine combustion systems that use stratified fuel/air regions in the cylinder having different reactivities, such as that described by Reitz, are known to work relatively well at low engine speeds and loads, where the various strata within the cylinder have a chance to fully develop, but the technology is not proven to work for higher engine loads, where the fuel amounts within the cylinder are increased and/or the incoming air to the cylinder is accelerated. Thus, the combustion system of Reitz may not be suitable for certain engine applications where higher loads are required and may not be able to compensate for changing environmental and operating conditions.

### SUMMARY

The disclosure describes, in one aspect, a four-stroke internal combustion engine, comprising at least one cylinder having a piston reciprocable between top dead center (TDC) and bottom dead center (BDC) positions. The engine includes a first fuel injector disposed to inject a first fuel into said cylinder, and a second fuel injector disposed to inject a second fuel into said cylinder such that stratified air/fuel regions having different reactivities are created within the at least one cylinder prior to combustion. The engine further includes at least one intake valve associated with the at least one cylinder. Operation of the at least one intake is in accordance with a Miller thermodynamic cycle. The engine also includes at least one exhaust gas recirculation system disposed to draw exhaust gas from the at least one cylinder and provide it to the at least one cylinder through the at least one intake valve. The engine includes at least one electronic controller disposed to receive at least one input signal indicative of the operating conditions of the internal combustion engine. The controller adjusts at least one of the intake valve timing and the amount of exhaust gas recirculation in response to said at least one input signal.

In another aspect, the disclosure describes a method for operating an internal combustion engine. The method includes storing a first fuel in a first fuel reservoir, the first fuel having a first reactivity, and storing a second fuel in a second fuel reservoir, the second fuel having a second reactivity. The method further includes introducing the first fuel to a variable volume defined by a piston moving in a cylinder at a first time when the piston is relatively closer to a bottom dead center (BDC) position, and then introducing the second fuel having a second reactivity into the variable volume at a second time when the piston is relatively further from the BDC position. The method includes receiving operating parameters at an electronic controller, the operating parameters being indicative of the operating conditions of the internal combustion engine, and processing the operating parameters in the electronic controller to determine a desired valve timing and/or a desired amount of exhaust gas recirculation. The engine is operated with variable valve timing and consistent with a Miller thermodynamic combustion cycle.

In another aspect, the disclosure describes a method for operating a four-stroke internal combustion engine. The engine is operated at an engine valve timing consistent with a Miller thermodynamic combustion cycle. The method includes storing a first fuel in a first fuel reservoir, the first fuel having a first reactivity, and storing a second fuel in a second fuel reservoir, the second fuel having a second reactivity. The first fuel is introduced to a variable volume defined by a piston moving in a cylinder at a first time, when the piston is relatively closer to a bottom dead center (BDC) position, thereby creating a first air/fuel mixture region having a first reactivity. The second fuel having a second reactivity is introduced into the variable volume at a second time, when the piston is relatively further from the BDC position, thereby creating a second air/fuel mixture region having a different reactivity than the first region. Ignition is initiated in the air/fuel mixture region having a higher reactivity. Operating parameters relative to the combustion are received at an electronic controller. The operating parameters are indicative of the operating conditions of the internal combustion engine, and are processed in the electronic controller to determine a desired valve timing and/or a desired amount of exhaust gas recirculation.

### BRIEF DESCRIPTION OF THE DRAWINGS

FIG. 1 is a block diagram for an engine system in accordance with the disclosure.

FIGS. 2-5 are cross sections of an engine cylinder at various operating positions in accordance with the disclosure.

FIG. 6 is a qualitative chart illustrating various engine operating conditions in accordance with the disclosure.

FIG. 7 is a block diagram for an engine controller in accordance with the disclosure.

FIG. 8 is a flowchart for a method in accordance with the disclosure.

### DETAILED DESCRIPTION

This disclosure relates to internal combustion engines and, more particularly, to internal combustion engines that operate using more than one fuel, and to machines or vehicles into which such engine systems may be operating. More specifically, this disclosure relates to an internal combustion engine operating under a Miller thermodynamic cycle, which should be understood to include valve timing adjustments effecting variable valve opening and closing events. For example, an engine intake valve may be closed before the intake stroke is completed, which is a process commonly referred to as an early intake closing cycle (“EIC”), or may be left open through the first part of the compression stroke, which is a process commonly referred to as a late intake closing cycle (“LIC”). Either of these processes can reduce the air or alter the ratio of an air/fuel mixture within the cylinder. In one aspect, the present disclosure may further relate to internal combustion engines having variable valve and/or fuel injection capability that can respond to certain environmental operating conditions.

In one disclosed embodiment, an engine operates using a high reactivity fuel such as diesel in conjunction with a low reactivity fuel such as gasoline, although alternative embodiments in which a single fuel having different reactivities or two other fuels are contemplated. In the various embodiments contemplated, fuels having different reactivities are delivered to engine cylinders by various methods including direct injection of one or more fuels into the cylinder and/or indirect injection methods. Indirect fuel injection methods can be tailored to the particular type of fuel being used. For example, a gaseous fuel such as propane or natural gas can be dispersed into the intake manifold of the engine for mixing with engine intake air, while a liquid fuel such as gasoline can be injected at or close to a cylinder intake port for mixing with air entering the cylinder.

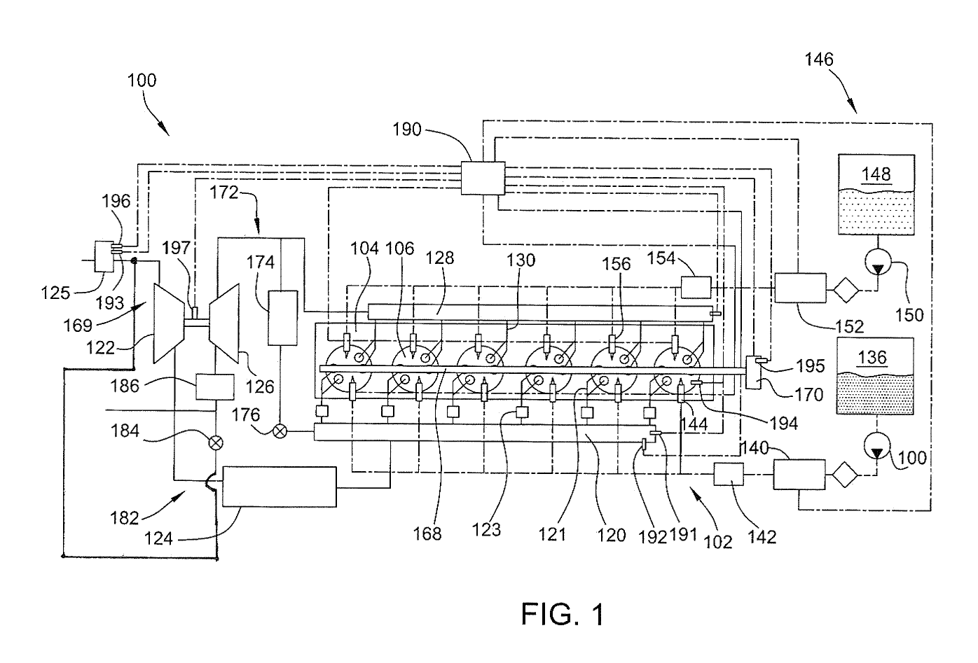

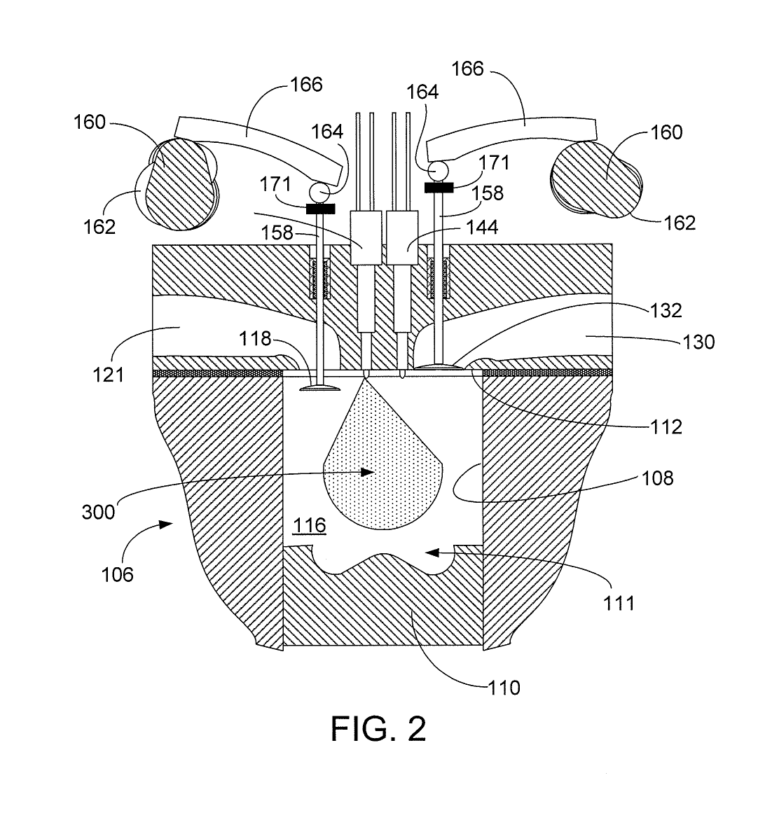

A block diagram for an engine system 100 is shown in FIG. 1. The engine system 100 includes an engine 102 having a cylinder case 104 that forms a plurality of engine cylinders 106. Although six cylinders 106 are shown, fewer or more cylinders arranged in an inline or another configuration such as a V-configuration may be used. As is best shown in FIG. 2, each engine cylinder 106 includes a bore 108 that slidably accepts therein a piston 110. The piston 110 forms a bowl 111 in its crown. A free end of the bore 108 is closed by what is commonly referred to as a flame deck surface 112 of a cylinder head 114. In this way, a variable volume 116 is defined between a top portion of the piston 110, the bore 108 and the flame deck surface 112, which varies as the piston 110 moves between top dead center (TDC) and bottom dead center (BDC) positions within the bore 108.

In the illustrated embodiment, an intake valve 118 selectively fluidly connects the variable volume 116 with an intake manifold or collector 120 (FIG. 1) via an intake runner 121. In the illustrated embodiment, each intake runner 121 includes a cooler 123 that operates as a heat exchanger to remove heat from intake air passing through the intake runner 121. In one embodiment, the coolers 123 use engine coolant as a heat sink but other types of coolers can be used. As best shown in FIG. 1, the intake manifold 120 receives air compressed by a compressor 122, which can optionally also be cooled in an intercooler 124 before entering the intake manifold 120. Air is provided to the compressor 122 through an air filter 125. Power to compress the air in the compressor 122 is provided by a turbine 126, which receives exhaust gas from an exhaust manifold or collector 128. When combustion in each cylinder is complete, exhaust gas from each cylinder 106 is collected in the exhaust manifold 128 from one or more exhaust runners 130, which communicate with and are selectively fluidly connectable with their respective cylinders 106 via exhaust valves 132, which are shown in FIG. 2. Although one intake and one exhaust valve 118 and 132 are shown in the cross section of FIGS. 2, more than one intake and exhaust valve can be connected to each cylinder. For example, two intake and two exhaust valves 118 and 132 are shown for each cylinder 106 in FIG. 1.

In the exemplary embodiment of FIG. 1, the engine 102 is configured to operate with first and second fuels having different reactivities such as diesel and gasoline. Both fuels are stored and supplied to the engine independently. Accordingly, a diesel fuel system 134 includes a diesel fuel reservoir 136 that supplies fuel to a diesel fuel pump 138. An optional diesel fuel conditioning module 140 may filter and/or otherwise condition the fuel that passes therethrough, for example, to heat the fuel at low temperature conditions, remove water, and the like. Pressurized diesel fuel is collected in a high-pressure rail or accumulator 142, from where it is provided to a diesel fuel injector 144 associated with each cylinder 106. As is also shown in FIG. 2, the diesel fuel injector 144 associated with each cylinder 106 is configured to inject a predetermined amount of diesel directly into the respective variable volume 116.

For the second fuel, a gasoline fuel system 146 includes a gasoline fuel reservoir 148 that supplies fuel to a gasoline pump 150. As with the diesel fuel, an optional gasoline conditioning module 152 may filter and/or otherwise condition the fuel that passes therethrough. Pressurized gasoline is provided to a high-pressure rail or accumulator 154, from where it is provided to a plurality of gasoline injectors 156, each of which is associated with each cylinder 106 and is configured to inject a predetermined amount of gasoline directly into the respective variable volume 116. In alternative embodiments, the gasoline injectors 156 may be disposed to inject fuel indirectly into the cylinders 106, for example, by providing the fuel into the respective intake runner 121 or by dispersing the gasoline in an aerosol mixture with the intake air within the intake manifold 120 from one or more injection locations (not shown) at a high, intermediate or low pressure. It is noted that, although two fuel injectors 144 and 156 are shown associated with each cylinder 106, a single fuel injector having the capability of injecting two fuels independently (not shown) can be used instead of the two separate injectors shown. For both the diesel and gasoline fuel systems 134 and 146, other additional or optional fuel system components such as low-pressure transfer pumps, de-aerators and the like can be used but are not shown for simplicity.

In reference now to the cross section shown in FIG. 2, the intake and exhaust valves 118 and 132 in one embodiment are actuated by pushrods 158. The pushrods 158 may cause each valve to open or close when a respective lobe 160 of one or more rotatable camshafts 162 pushes onto a respective cam follower 164 via a valve bridge 166 in the known fashion. In the embodiment illustrated, the engine 102 has a variable cam timing, which enables the selective shifting and/or elongation of the opening stroke of the intake valves 118 and the exhaust valves 132. Accordingly, in the embodiment shown in FIG. 1, a single camshaft 168 is caused to rotate during engine operation. A phase angle of the camshaft can be selectively altered via a specialized actuator 170, which is responsive to a command signal. In general, the variable valve timing for the engine 102 can be accomplished in any known way, including the addition of devices and actuators that act on the valve pushrods to keep the respective valve open for a prolonged period or close the valve in an early fashion. Relative to shifting valve timing, various mechanisms can be used. One example of a variable valve timing arrangement that can operate to shift valve timing is described in copending U.S. patent application Ser. No. 12/952,033, which discusses a mechanism configured to provide a predetermined phase rotation of the camshaft relative to the engine crankshaft that results in a phase shift of valve opening and closing events during engine operation. Another example of mechanism used for varying valve time is actuators 171 as shown in FIG. 2. The actuators may be electric, hydraulic or any other device that is capable of acting on the pushrods 158 to hold the respective intake valve 118 or exhaust valve 132 open and thereby vary the valve timing.

In one embodiment, the engine 102 can include an exhaust recirculation (EGR) system 169, which operates to mix exhaust gas drawn from the engine's exhaust system with intake air of the engine to displace oxygen and generally lower the flame temperature of combustion within the cylinders. Generally, exhaust gas that travels through the EGR system 169 has a higher temperature than the intake air it is mixed with. Two exemplary EGR systems 169 are shown associated with the engine 102 in FIG. 1, but it should be appreciated that these illustrations are exemplary and that either one, both, or neither can be used on the engine. It is contemplated that an EGR system 169 of a particular type may depend on the particular requirements of each engine application.

A first exemplary embodiment of an EGR system 169 is for a high-pressure EGR system 172 that includes an optional EGR cooler 174 and an EGR valve 176. The EGR cooler 174 and EGR valve 176 are connected in series between the exhaust and intake manifolds 128 and 120. This type of EGR system is commonly referred to as high-pressure loop system because the exhaust gas is recirculated from a relatively high-pressure exhaust location upstream of the turbine 126 to a relatively high-pressure intake location downstream of a compressor 122. In the high-pressure EGR system 172, the exhaust gas is cooled in the EGR cooler 174, which may be embodied as a jacket cooler that uses engine coolant as a heat sink. The flow of exhaust gas is metered or controlled by the selective opening of the EGR valve 176, which can be embodied as any appropriate valve type such as electronically or mechanically actuated valves.

A second exemplary embodiment of a low-pressure loop EGR system 182 includes an EGR valve 184 that is fluidly connected between a low-pressure exhaust location downstream of the turbine 126 and a low-pressure intake location upstream of the compressor 122. As shown, the exhaust location is further disposed downstream of an after-treatment device 186, which can include various components and systems configured to treat and condition engine exhaust gas in the known fashion, and upstream of the intercooler 124, which can be embodied as an air-to-air cooler that removes heat from the intake air of the engine.

The engine system 100 further includes an electronic controller 190, which monitors and controls the operation of the engine 102 and other components and systems associated with the engine such as fuel supply components and systems, as well as other structures associated with the engine such as machine components and systems and the like. More specifically, the controller 190 is operably associated with various sensors that monitor various operating parameters of the engine system 100. In FIG. 1, the various communication and command channels associated with the controller 190 are shown in dot-dashed lines for illustration but may be embodied in any appropriate fashion, for example, via electrical conductors carrying analog or digital electrical signals, via informational transfer channels within a local area computer network, via a confined area network (CAN) arrangement, and/or via any other known configuration.

The controller 190 includes various sub-modules as shown and described in more detail below, but it should be appreciated that the functionality of the modules illustrated is not exhaustive. Accordingly, fewer or more functions than those shown may be integrated with the controller 190. Moreover, the controller 190 shown here is an electronic control device or, stated differently, an electronic controller. As used herein, the term electronic controller may refer to a single controller or may include more than one controller disposed to control various functions and/or features of the engine. For example, a master controller, used to control systems associated with the engine, such as a generator or alternator, may be cooperatively implemented with a motor or engine controller, used to control the engine 102. In this embodiment, the term “controller” is meant to include one, two, or more controllers that may be associated with one another and that may cooperate in controlling various functions and operations of the engine 102. The functionality of the controller, while shown conceptually in the figures to include various discrete functions, may be implemented in hardware and/or software without regard to the discrete functionality shown. Accordingly, various interfaces of the controller are described relative to components of the engine 102. Such interfaces are not intended to limit the type and number of components that are connected, nor the number of controllers that are described.

Relevant to the present disclosure, the engine system 100 includes an intake manifold pressure sensor 191 and an intake manifold air temperature sensor 192 disposed to measure the pressure and temperature of incoming air to the engine and provide signals indicative of the measured parameters to the controller 190. As shown, the intake manifold pressure sensor 191 is disposed to measure air pressure within the intake manifold 120. The intake manifold air temperature sensor 192 is disposed to measure air temperature within the intake manifold 120. The engine system 100 further includes a barometric pressure sensor 193 that, as shown, is located at the air filter 125 and is disposed to measure and provide to the controller 190 a signal indicative of the barometric pressure and thus the altitude of engine operation. Similarly, the engine system 100 further includes an ambient air temperature sensor 196 that, as shown, is located at the air filter 125 and is disposed to measure and provide to the controller 190 a signal indicative of the ambient air temperature.

The engine system 100 additionally includes a cylinder pressure sensor 194, which is configured to measure and provide to the controller 190, in real time, a signal indicative of fluid pressure within the cylinder 106 into which the sensor is placed. Although one sensor is shown, it should be appreciated that more than one cylinder may have such a pressure sensor associated therewith. A timing sensor 195 provides a signal to the controller 190 that is indicative of the rotational position of the crankshaft and/or camshaft. Based on this information, the controller 190 can infer, at all times, the position of each intake and exhaust valve 118 and 132 as well as the position of each piston 110 within its respective cylinder 106. Additionally an EGR system usage signal 197 can provide a signal to the control indicative of the use of the EGR system 169 and the amount of exhaust gas mixed with the intake air. This information can be used to control and adjust engine operation. The engine system 100 can further include an oxygen sensor 198 (not shown) typically disposed to measure the oxygen content in the exhaust gas of the engine or, alternatively, a difference between the amount of oxygen in the exhaust gas and the amount of oxygen outside of the engine system 100. Many other sensors associated with other engine components can include fuel pressure sensors 199 and 200 associated with the diesel fuel injector 144 and the gasoline fuel injector 156 respectively.

The controller 190 is further configured to provide commands to various actuators and systems associated with the engine 102. In the illustrated embodiment, the controller 190 is connected to the diesel and gasoline fuel injectors 144 and 156 and is configured to provide them with command signals that determine the timing and duration of fuel injection within the cylinders 106. The controller 190 further provides a timing phase command to the camshaft phase actuator 170 that dynamically adjusts valve timing during operation. The controller 190 can also provide a timing phase command to actuators 171, if present, to dynamically adjust the valve timing during operation. As shown, the controller 190 further provides commands that control the operation of the diesel and gasoline fuel conditioning modules 140 and 152 when either or both of these modules include functionality operating to change or adjust fuel properties, for example, by mixing additives that affect the cetane rating or otherwise determine the reactivity of the respective fuels.

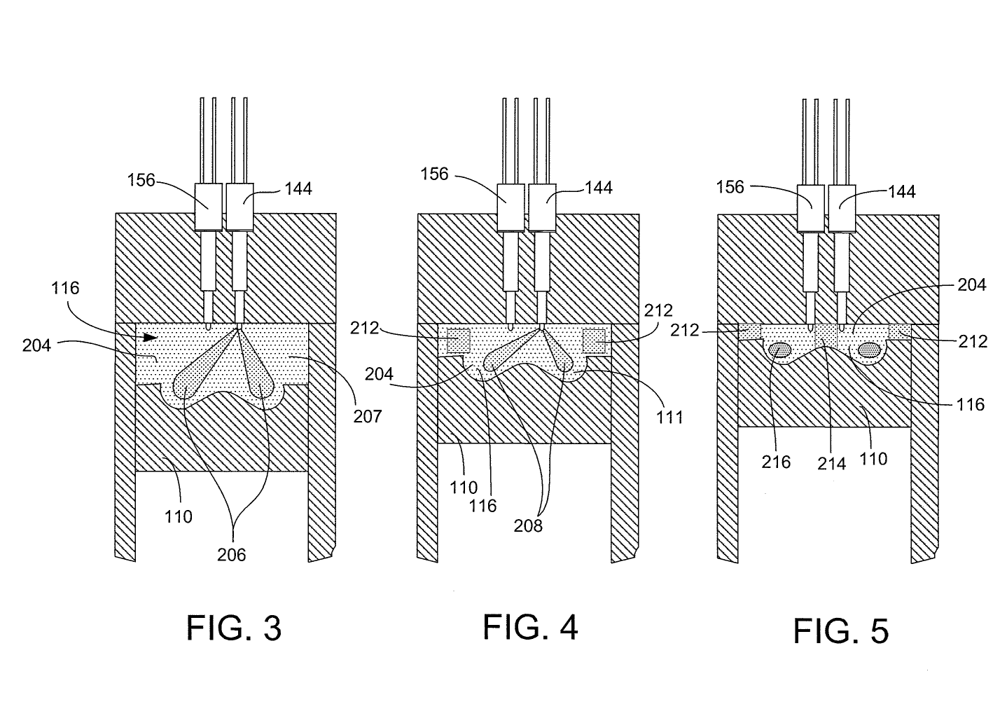

An exemplary series of injection events for fuels having different reactivities that can be performed in accordance with one embodiment of the disclosure to provide stratified fuel/air mixture regions having different reactivities within a cylinder are shown in the cross sections of FIGS. 2-5. Beginning with FIG. 2, an initial fuel charge having a first, low reactivity, for example, gasoline, is injected into the variable volume 116 while the piston 110 is still undergoing an intake stroke or shortly after the intake stroke has been completed. Delivery of the first fuel into the variable volume 116 can be accomplished by dispersion of a gasoline plume 202 that is provided through the gasoline fuel injector 156 early enough to permit a somewhat uniform concentration of gasoline vapor throughout the variable volume 116. In an alternative embodiment, the first fuel may be mixed with intake air as the intake air enters the cylinder through the intake port. In the illustrated embodiment, gasoline injection can be performed at any time during and/or shortly after the intake stroke. As the illustrated embodiment operates using a Miller combustion cycle, operation of the intake valve 118 can be adjusted according to a LIC or EIC type of Miller operation, the extent of which is determined by the controller 190. After completion of the first injection shown in FIG. 2, sufficient time passes until a relatively uniform and homogeneous air/fuel mixture 204 (FIG. 3) having a first, relatively low reactivity occupies substantially the entire variable volume 116 of the cylinder.

The air/fuel mixture 204 having the first, relatively low reactivity is compressed at the early stage of a compression stroke while the piston 110 moves away from the BDC position and towards the TDC position, as shown in FIG. 3. As the illustrated embodiment operates using a LIC Miller combustion cycle, the intake valve 118 can remain open during the initial stage of the compression stroke. At around this stage, the second fuel, which has a higher reactivity such as diesel, is injected into the variable volume 116 through the diesel injector 144. As shown, a diesel plume 206 is injected into the variable volume anywhere between the BDC position of the piston 110 (180 degrees of crankshaft rotation before TDC) and 10 degrees before the TDC position (0 degree position). During this period, two or more diesel injections may be provided. The injection shown in FIG. 3 is provided in about the first half of the compression stroke of the piston 110 while the piston is at a relatively greater distance from the flame deck surface such that the second injection plume 206 is directed towards the outer peripheral portions of the variable volume 116, which are sometimes referred to as the squish regions 207 when describing pistons having a bowl and a raised rim that “squishes” fluids in conjunction with the flame deck surface as the piston approaches the TDC position. These fuel injections can be carried out after the intake valve has closed so as to avoid egress of the second fuel into the intake manifold.

A third injection of high-reactivity fuel (here, diesel) is shown in FIG. 4, which depicts a position of about 30 degrees before TDC. The third fuel injection plume (second diesel plume) 208 of this injection event is directed primarily towards the inner portion of the piston bowl 111 because of the relative proximity of the piston 110 to the injector 144. In the time after the second injection was completed and before this third injection occurs, the second injection plume 206 (FIG. 3) has begun to diffuse or has already diffused from the squish region and mixes with the low-reactivity air/fuel mixture 204 from the fuel charge from the first fuel injection plume 202 (FIG. 2) to form a region 212 of intermediate reactivity at or near the squish region, as shown in FIG. 4. The second diesel plume 208 also begins to diffuse such that, after completion of this injection event and as the piston 110 continues to travel towards TDC, at least two additional regions having different reactivities are created.

As shown in FIG. 5, following completion of the third injection, the regions of intermediate reactivity 212 remain in the squish region, and a new region of intermediate reactivity 214 forms along a central portion of the bore, primarily by diffuse fuel from the third injection event near a tip of the injector 144. The fuel from the third injection event, i.e. the second diesel plume 208, has also formed a third region 216 having relatively high reactivity within the piston bowl. The third region 216 is formed primarily by evaporation of high reactivity fuel provided during the third injection event within the relatively enclosed space of the piston bowl.

Overall, the variable volume 116 at the position near TDC as shown in FIG. 5 includes regions having three different reactivities, which are stratified relative to one another: (1) the background region made up from the air/fuel mixture 204 that occupies substantially the entire volume 116, which has a relatively low reactivity provided by the initial fuel injection charge 202 (FIG. 2) that has now substantially diffused, (2) the second and third regions 212 and 214 disposed in the squish region and along the central portion of the volume 116 that have intermediate reactivity, which were created by the second and third injection events, and (3) the relatively high reactivity region 216 that is disposed substantially within the piston bowl and was created after the third injection event. Combustion may begin at around this time at the high reactivity region 216 and propagate over time to the intermediate and lower reactivity regions 204, 212 and 216.

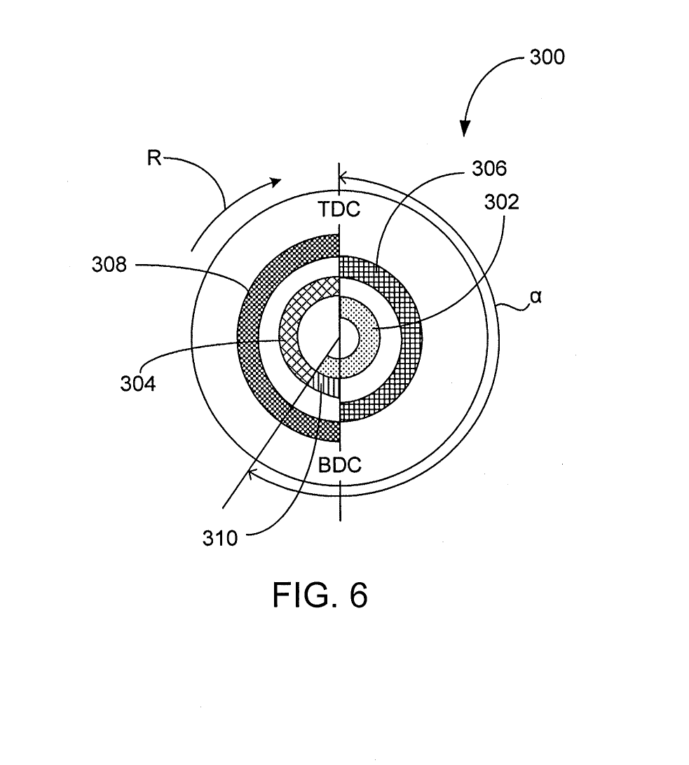

In the illustrated embodiment, the engine 102 may be operating under a LIC Miller thermodynamic cycle, in which the intake valve 118 is kept open after the piston 110 has passed its BDC position, or alternatively under an EIC Miller thermodynamic cycle, in which the intake valve 118 closes early during the intake stroke and before the piston reaches the BDC position. To illustrate operation under the LIC Miller cycle, a qualitative valve timing chart 300 is shown in FIG. 6. Although typical valve timing charts are configured based on the particular structures of each engine, the chart 300 is shown simplified and without valve lead, lag, or overlap effects for simplicity.

The chart 300 represents various intake and exhaust valve opening events with respect to the rotation of the engine's crankshaft, which is viewed from the front as it rotates in the direction of the arrow, R. Accordingly, TDC is shown at the top of the chart 300 and represents the crankshaft position (0 degrees) at which the piston 110 is at the topmost position in the cylinder 106 as shown in FIG. 2. Similarly, BDC is shown at the bottom of the chart 300 and represents the position at which the piston 110 is at the bottommost position in the cylinder 106 (180 degrees). In the chart, an intake stroke 302 extends from TDC, at which point the intake valve 118 shown as instantaneously opening for purposes of the present disclosure, to an angle belonging in the range of about 1 to 100 degrees before or after BDC over an angle, α (alpha), which is generically illustrated. The compression stroke 304 begins after the intake valve 118 has closed, which in the present discussion is shown to occur instantaneously, and extends up to TDC. A combustion or power stroke 306 immediately follows until about the BDC piston position, and is followed by an exhaust stroke 308 during which the piston travels back towards the TDC position. The initiation of the power stroke 306 can be selectively advanced or retarded by permitting auto-ignition to occur in a compression ignition engine by creating appropriate conditions within the combustion cylinder.

As shown by the shaded area 310 in the chart 300, in accordance with the LIC Miller cycle, the opening and closing of the intake valve prolongs the intake stroke 302 past the BDC position, which delays the compression stroke 304. It should be appreciated that in an early intake closing (“EIC”) type of Miller cycle, the valve timing chart would be different.

The actuation of the intake valve 118 is advantageously variable based on other engine operating and environmental conditions such that engine operation may be optimized under most operating conditions. The timing of the power stroke 306 can also be selectively controlled in the engine 100. The duration of the intake stroke 302 and/or the initiation of the combustion stroke 306 are two parameters that can be actively controlled in the engine 102. Such control can be effective in improving fuel economy, adjusting for altitude effects, adjusting for effects of ambient and engine temperatures, compensating for different fuel types, and generally providing other advantages to the operation of the engine 102 as is described in further detail in the paragraphs that follow.

In one embodiment, engine operation is adjusted in part by controlling the amount and temperature of the intake air or mixture of air with exhaust gas that is provided to the cylinders. Such adjustment is especially important to ensure reliable ignition of the stratified air/fuel mixture regions having different reactivities within the cylinder. For example, engine operation at a high altitude may require a valve timing adjustment to provide a higher volume of intake air into the cylinder to ensure that sufficient oxygen is present for complete combustion. At the same time, engine operation at low engine speeds and loads may benefit from a reduced intake mixture volume to improve engine efficiency. A similar adjustment can be made dynamically during operation to account not only for the operating state of the engine, but also to mitigate effects to combustion initiation by environmental factors such as temperature. The engine 102 can thus compensate for varying environmental and engine operating conditions by adjusting, among other parameters, the valve timing (or the amount of Miller) and the amount of EGR that the engine 102 uses. Generally, the engine will compensate for higher intake air temperatures by increasing the amount of Miller and/or reducing the amount of EGR usage. The amount of Miller and the amount of EGR can be optimized such that there is stable ignition control while maximizing fuel efficiency and emissions.

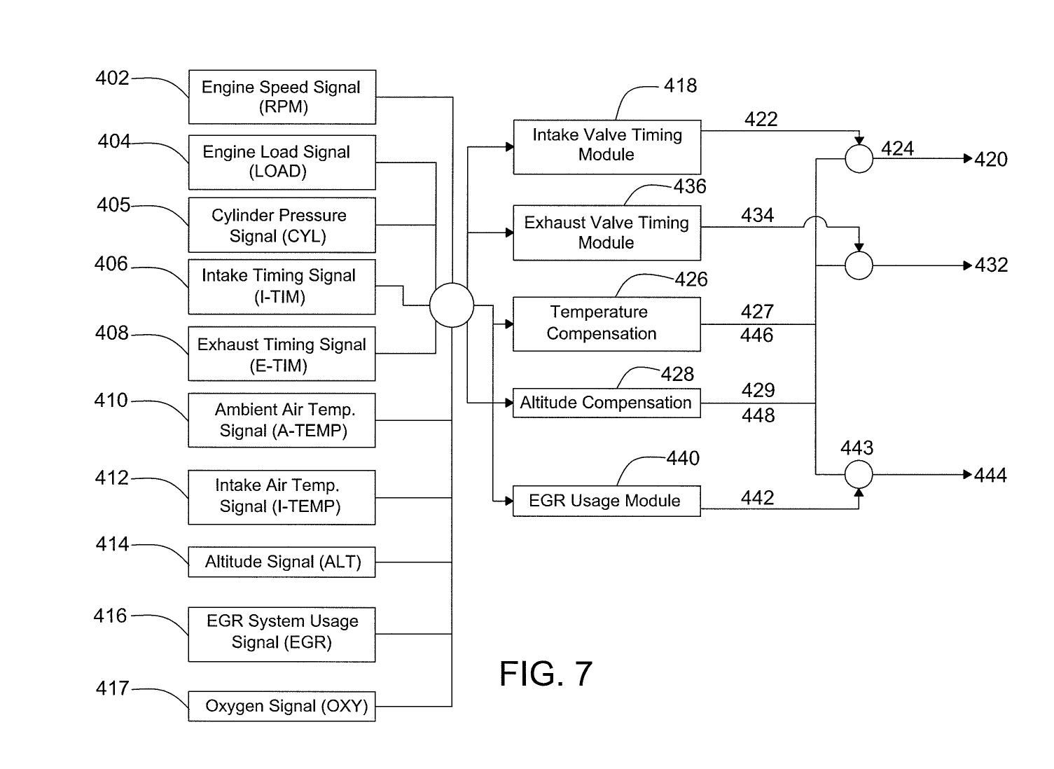

A block diagram showing some of the inputs to the controller 190 is shown in FIG. 7. As shown, the controller 190 is disposed to receive various inputs indicative of engine operating parameters and other parameters. Specifically, among the various signals that the controller 190 receives are an engine speed signal (RPM) 402, an engine load signal (LOAD) 404, which may be expressed as a torque applied to the engine, a cylinder pressure signal (CYL-P) 405, an intake valve timing signal (I-TIM) 406, an exhaust cam timing signal (E-TIM) 408, an ambient air temperature signal (A-TEMP) 410, an intake temperature signal (I-TEMP) 412, an altitude signal (ALT) 414, an EGR system usage signal (EGR) 416, and oxygen signal (OXY) 417, and other parameters that are not shown here, such as intake manifold pressure, exhaust pressure, engine oil or coolant temperature, ignition timing and the like. Of the illustrated signals, the RPM 402 may be provided as an engine speed value in revolutions per minute, or it may alternatively be provided as a raw series of pulses from the crankshaft position sensor, which are then used to derive the engine speed. The LOAD 404 may be provided directly by a load sensor (not shown), or it may alternatively be calculated indirectly from other parameters, such as the current and voltage output of a generator or alternator connected to the engine (not shown), a pressure and flow of hydraulic fluid provided by a fluid pump connected to the engine (not shown), or any other appropriate parameters indicative of the load applied to the engine during operation. The CYL-P 405 may be provided by the cylinder pressure sensor 194. The I-TIM 406 and E-TIM 408 may be provided from position sensors associated with the intake valve 118 and exhaust valve 132, actuators or camshaft 162 associated with the intake and exhaust valves of the engine such as the timing sensor 195. The ALT 414 may be provided by a barometric pressure sensor 193, while the A-TEMP 410 may be provided by the ambient air temperature sensor 196 and the I-TEMP 411 may also be provided by the intake manifold air temperature 192. Similarly, the EGR 416 may be provided by the EGR system usage signal 197 and the OXY 417 may be provided by the oxygen sensor 198.

The controller 190 includes an intake valve timing module 402, which receives at least an intake valve timing signal 406, the load 404, and the engine speed 402. The intake valve timing module 418 performs calculations to provide an intake valve phase signal 420. The intake valve phase signal 420 may be the same as or provide a basis for determination of a signal controlling the operation of a phaser device, for example, the camshaft phase actuator 170 or actuators 171. Although any suitable implementation may be used for the intake valve timing module 418 the intake valve timing module 418 can include a lookup table that is populated by valve timing values or valve phase signals that are tabulated against engine speed 402, engine load 404, and any other parameters. The timing values in the table are arranged to provide timing advance or retard, depending on the desired conditions.

Thus, the table receives the engine speed 402 and load 404 during operation, and uses these parameters to lookup, interpolate, or otherwise determine a desired intake timing value. The desired intake timing value is compared to the actual intake timing 406. The intake timing error is provided to a control algorithm, which yields an intake valve timing command signal 422. The control algorithm may be any suitable algorithm such as a proportional-integral-derivative (PID) controller or a variation thereof, a model based algorithm, a single or multidimensional function and the like. Moreover, the control algorithm may include scheduling of various internal terms thereof, such as gains, to enhance its stability.

The intake valve timing command signal 422 is optionally compensated by the addition of compensation terms at a junction 424 to provide an intake valve phase signal 420. In the illustrated embodiment, the compensation terms are a temperature compensation term 426 and an altitude compensation term 428, although many other compensation terms are contemplated. These compensation terms are optional and augment the flexibility of engine operation under different environmental conditions. More specifically, the temperature compensation term 426 and altitude compensation term 428 are timing advance or retard values that depend on the operating conditions of the engine 102. Temperature signals, such as A-TEMP 410 and I-TEMP 411, are provided to the temperature compensation module 426. In the illustrated embodiment, the temperature compensation module 426 may include a function that provides an appropriate timing advance or retard value 427 based on the expected air density at various operating temperatures. In this way, the temperature compensation module 426 may provide a term tending to change intake valve timing, which can result in a lessened Miller effect for higher operating temperatures. Similarly, the altitude signal 412 is provided to an altitude compensation module 428. In the illustrated embodiment, the altitude compensation module 428 may include a function that provides an appropriate timing advance or retard value 429 based on the expected air density at various altitudes. In this way, the altitude compensation module 428 may provide a term tending to change intake valve timing, which results in an increased Miller effect for higher altitudes.

In engines having separate intake and exhaust valve camshafts, the controller 190 may be further configured to provide a separate exhaust valve phase signal 432. The exhaust valve phase signal 432 in the embodiment illustrated is determined in a fashion similar to that of the intake valve phase signal 422. Accordingly, the exhaust valve phase signal 432 is determined by an altitude and temperature compensated exhaust valve timing signal 434 that is provided by an exhaust valve timing module 436. The exhaust valve timing module 436 receives as inputs the engine speed 402 and load 404 as well as the exhaust valve timing 408. The exhaust valve timing module 436 may operate similar to the intake valve timing module 418 and include similar elements and algorithms. The exhaust valve timing signal 434 may be compensated by use of the same or different compensation terms as used for the intake valve timing command, namely the temperature compensation signal 427 and the altitude compensation term 429. It should be appreciated that in engines having a single camshaft operating both intake and exhaust valves, a separate exhaust valve phase signal will not be required.

Like the timing adjustments above, the controller 190 can also adjust the use of the EGR system 169 in response to operating conditions. The controller 190 includes an EGR usage module 440 which receives at least the EGR system usage 416, the load 404, the engine speed 402, and in some embodiments the oxygen signal 417. The EGR usage module 440 performs calculations to provide an EGR usage signal 442. The EGR usage signal 442 may be the same as or provide a basis for determination of a signal controlling the operation of the EGR system 169. Although any suitable implementation may be used for the EGR usage module 440 the EGR usage module 440 can include a lookup table that is populated by EGR usage values that are tabulated against engine speed 402, engine load 404, and any other parameters. The EGR usage values in the table are arranged to provide EGR usage increase or decrease, depending on the desired conditions.

Thus, the table receives the engine speed 402 and load 404 during operation, and uses these parameters to lookup, interpolate, or otherwise determine a desired EGR usage value. The desired EGR usage value is compared to the EGR usage 416. The EGR usage error is provided to a control algorithm, which yields an EGR usage command signal 442. The control algorithm may be any suitable algorithm such as a proportional-integral-derivative (PID) controller or a variation thereof, a model based algorithm, a single or multidimensional function and the like. Moreover, the control algorithm may include scheduling of various internal terms thereof, such as gains, to enhance its stability.

The EGR command signal 442 is optionally compensated by the addition of compensation terms at a junction 443 to provide an EGR final command signal 444. In the illustrated embodiment, the compensation terms are a temperature compensation 426 and an altitude compensation term 428, although many other compensation terms are contemplated. These compensation terms are optional and augment the flexibility of engine operation under different environmental conditions. More specifically, the temperature compensation 426 and altitude compensation term 428 are EGR usage increase or decrease values that depend on the operating conditions of the engine 102. Temperature signals, such as A-TEMP 410 and I-TEMP 411, are provided to the EGR usage compensation module 440. In the illustrated embodiment, the temperature compensation module 426 may include a function that provides an appropriate EGR usage increase or decrease 446 based on the expected air density at various operating temperatures. In this way, the temperature compensation module 426 may provide a term tending to change amount of EGR usage, which results in decreased EGR usage at higher operating temperatures. Similarly, the altitude signal 412 is provided to an altitude compensation module 428. In the illustrated embodiment, the altitude compensation module 428 may include a function that provides an appropriate EGR usage increase or decrease 448 based on the expected air density at various altitudes. In this way, the altitude compensation module 428 may provide a term tending to change amount of EGR usage, which results in a lessened less EGR usage at higher altitudes.

The controller 190 also includes a fuel control module 450 (not shown) that can control the injection timing and duration of the fuel injectors 144 and 156 of the reactivity compression controlled ignition engine 102. The fuel control module can receive any number of inputs including the engine speed signal (RPM) 402, the engine load signal (LOAD) 404, the cylinder pressure signal (CYL-P) 405, the intake valve timing signal (I-TIM) 406, the exhaust cam timing signal (E-TIM) 408, the ambient air temperature signal (A-TEMP) 410, the intake temperature signal (I-TEMP) 412, the altitude signal (ALT) 414, the EGR system usage signal (EGR) 416, the oxygen signal (OXY) 417, and other parameters, such as intake manifold pressure, exhaust pressure, engine oil or coolant temperature, ignition timing and the like. From these inputs and based on desired operating conditions such as desired engine speed and desired engine load the fuel control module can control the timing and duration of the fuel injectors 144 and 156 to control the timing and amount of gasoline and diesel fuel that are injected into each of the cylinders 106. The injection timing and amount of each of the fuels can affect the ignition of the reactivity controlled compression ignition engine and can be varied to meet appropriate operating conditions.

### INDUSTRIAL APPLICABILITY

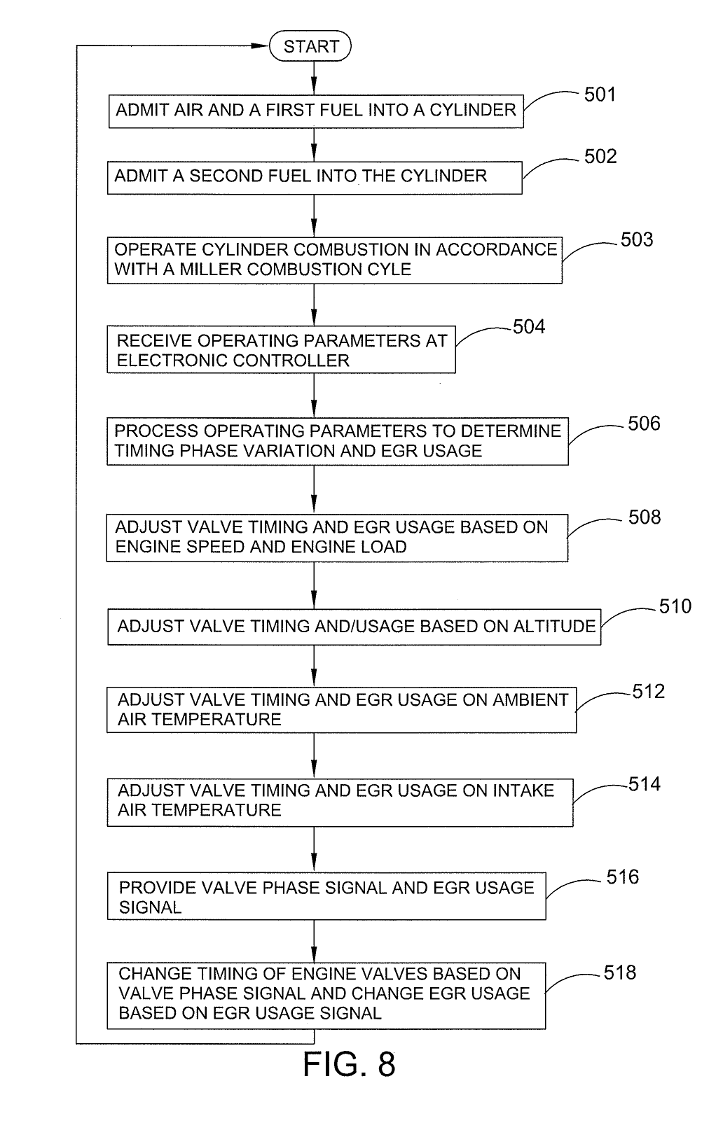

The present disclosure is applicable to internal combustion engines and, more particularly, to engines operating with more than one fuel using a variable Miller cycle. A flowchart for a method of operating a variable Miller cycle for reactivity controlled compression ignition engine is shown in FIG. 8. A first fuel is admitted to an engine cylinder 501 followed by a second fuel 502 creating a stratified region. The fuels are combusted in accordance with an engine operating on a Miller cycle 503. An electronic controller is disposed to receive various engine and other operating parameters at 504 that are indicative of the operating parameters of the engine. The electronic controller processes the parameters received to determine a timing phase variation and EGR usage at 506. The timing phase variation is configured to provide relatively high Miller effects during operation of the engine such that the amount of fuel/air mixture in the engine cylinders is sufficient to yield a desired speed and torque output. Similarly the EGR usage is configured to provide a relatively high amount of EGR usage such that the amount of fuel/air mixture in the engine cylinders is sufficient to yield a desired speed and torque output.

In one embodiment, the valve phase changes are optionally variable depending on the engine load and engine speed, altitude, ambient air temperature, intake air temperature and other parameters. In general, any parameter that is indicative of the air density or concentration of oxygen, which is required for combustion, and/or fuel, may be used as an indication of operating conditions of the engine during combustion. In one embodiment, the valve timing and EGR usage are optionally adjusted at 508 based on engine speed and load. The valve timing and EGR usage can also be optionally adjusted or compensated at 510 based on altitude. Additionally the valve timing and EGR usage can also be optionally adjusted or compensated based on ambient air temperature at 512 and/or intake air temperature at 514.

A valve phase signal and an EGR usage signal are provided at 516 to vary the valve timing and the EGR usage respectively. Accordingly, the timing of the engine valves is changed and the amount of EGR usage is changed. In the disclosed embodiment, a valve phase signal is provided to at least one control valve to affect the valve timing and an EGR usage signal is provided to the EGR system to affect the EGR usage at 518. The process may be repeated continuously to adjust or shift the timing phase of the engine valves and the EGR system during operation of the engine.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An internal combustion engine, comprising:
at least one cylinder having a piston reciprocable between top dead center (TDC) and bottom dead center (BDC) positions;
a first fuel injector disposed to inject a first fuel into said cylinder;
a second fuel injector disposed to inject a second fuel into said cylinder;
at least one intake valve associated with the at least one cylinder, the at least one intake valve being configured to open and close and having an intake valve timing associated with such opening and closing, wherein the intake valve operates in accordance with a Miller thermodynamic cycle;
at least one exhaust gas recirculation system disposed to draw exhaust gas from the at least one cylinder and provide an amount of exhaust gas recirculation to the at least one intake valve;
an electronic controller disposed to receive at least one input signal indicative of the operating conditions of the internal combustion engine, wherein the controller adjusts at least one of the intake valve timing and the amount of exhaust gas recirculation in response to said at least one input signal.

2. The engine of claim 1, wherein the first fuel has a different fuel reactivity than the second fuel.

3. The engine of claim 1, configured to activate the first fuel injector to inject the first fuel during an intake-compression cycle forming a first region; and to activate the second injector to introduce the second fuel later in the intake-compression cycle to form a second region.

4. The engine of claim 3, wherein the first region has a different fuel reactivity than the second region.

5. The engine of claim 4, wherein the first fuel is gasoline and the second fuel is diesel, and wherein a combustion that occurs in the at least one cylinder is a reactivity controlled compression ignited combustion.

6. The engine of claim 1, wherein the at least one input signal includes at least one of engine speed, engine load, intake air oxygen concentration, altitude, ambient air temperature, intake air pressure, combustion timing, and intake air temperature.

7. The engine of claim 1, wherein the at least one exhaust gas recirculation system is a high-pressure exhaust gas recirculation system

8. The engine of claim 1, wherein the at least on exhaust gas recirculation system is a low-pressure exhaust gas recirculation system.

9. A method for operating an internal combustion engine, comprising:
storing a first fuel in a first fuel reservoir, the first fuel having a first reactivity;
storing a second fuel in a second fuel reservoir, the second fuel having a second reactivity;
introducing the first fuel to a variable volume defined by a piston moving in a cylinder at a first time when the piston is relatively closer to a bottom dead center (BDC) position;
introducing the second fuel having a second reactivity into the variable volume at a second time when the piston is relatively further from the BDC position;
operating the engine at an engine valve timing in a fashion consistent with a Miller thermodynamic combustion cycle;
receiving operating parameters at an electronic controller, the operating parameters being indicative of the operating conditions of the internal combustion engine;
processing the operating parameters in the electronic controller to determine at least one of a desired valve timing, and a desired amount of exhaust gas recirculation.

10. The method of claim 9, wherein the first reactivity is different than the second reactivity.

11. The method of claim 9, wherein the first fuel forms a first region in the cylinder and the second fuel forms a second region in the cylinder, wherein the first region has a different reactivity than second region.

12. The method of claim 9, wherein the first fuel is gasoline and the second fuel is diesel.

13. The method of claim 9, wherein the processing of the operating parameters involves determining at least one of a desired valve timing, and a desired amount of exhaust gas recirculation based on a then-present engine speed and engine load.

14. The method of claim 9, wherein the processing of the operating parameters involves determining at least one of a desired valve timing, and a desired amount of exhaust gas recirculation based on altitude.

15. The method of claim 9, wherein the processing of the operating parameters involves determining at least one of a desired valve timing, and a desired amount of exhaust gas recirculation based on a parameter indicative of intake air density.

16. The method of claim 9, wherein the processing of the operating parameters involves determining at least one of a desired valve timing, and a desired amount of exhaust gas recirculation based on intake air oxygen concentration and intake air pressure.

17. A method for operating an internal combustion engine, comprising:
operating the engine at an engine valve timing in a fashion consistent with a Miller thermodynamic combustion cycle;
storing a first fuel in a first fuel reservoir, the first fuel having a first reactivity;
storing a second fuel in a second fuel reservoir, the second fuel having a second reactivity;
introducing the first fuel to a variable volume defined by a piston moving in a cylinder at a first time when the piston is relatively closer to a bottom dead center (BDC) position thereby creating a first region having a first reactivity;
introducing the second fuel having a second reactivity into the variable volume at a second time when the piston is relatively further from the BDC position thereby creating a second region with a different reactivity than the first region;
initiating ignition in the second region by a reactivity controlled compression ignited combustion;
receiving operating parameters at an electronic controller, the operating parameters being indicative of the operating conditions of the internal combustion engine; and
processing the operating parameters in the electronic controller to determine at least one of a desired valve timing, and a desired amount of exhaust gas recirculation.

18. The method of claim 17, wherein operating the engine consistent with the Miller thermodynamic combustion cycle is accomplished by at least one of:
maintaining at least one intake valve associated with the cylinder of the engine open beyond a BDC position of a piston such that an intake stroke is generally prolonged and a compression stroke is generally abridged under a late intake closing (LIC) type of engine operation, and
closing the at least one intake valve before the BDC position of the piston such that the intake stroke is generally abridged and the compression stroke is generally prolonged under an early intake closing (EIC) type of engine operation.

19. The method of claim 18, wherein determining the at least one of desired valve timing and timing phase variation is consistent with:
quickening the closing of the at least one intake valve when the engine is operating under a LIC type of operation, or
delaying the closing of the at least one intake valve when the engine is operating under an EIC type of operation,
such that an effect of the Miller cycle is decreased when the operating parameters are indicative of at least one of a high altitude, a high ambient temperature, or a high intake air temperature.

20. The method of claim 18, wherein determining the at least one of desired valve timing and timing phase variation is consistent with:
delaying the closing of the at least one intake valve when the engine is operating under a LIC type of operation, or
quickening the closing of the at least one intake valve when the engine is operating under an EIC type of operation,
such that an effect of the Miller cycle is decreased when the operating parameters are indicative of high altitude, low ambient temperature, or a low intake temperature.
